(19) United States
(12) Patent Application Publication
(10) Pub. No.: US 2013/0159555 A1
(43) Pub. Date: Jun. 20, 2013

(54) INPUT COMMANDS

(71) Applicants: Peter D. Rosser, Kirkland, WA (US); Christian Klein, Duvall, WA (US); Anthony R. Young, Sammamish, WA (US); Arnab Choudhury, Seattle, WA (US); Alexander D. Tudor, Woodinville, WA (US)

(72) Inventors: Peter D. Rosser, Kirkland, WA (US); Christian Klein, Duvall, WA (US); Anthony R. Young, Sammamish, WA (US); Arnab Choudhury, Seattle, WA (US); Alexander D. Tudor, Woodinville, WA (US)

(73) Assignee: MICROSOFT CORPORATION, Redmond, WA (US)

(21) Appl. No.: 13/331,886

(22) Filed: Dec. 20, 2011

(51) Int. Cl. G06F 3/00

(52) U.S. Cl. 710/5

(57) ABSTRACT

Input command techniques are described. In one or more implementations, a computing device processes one or more inputs that are received from one or more input sources to determine a command that corresponds to the one or more inputs. The command is exposed to one or more controls that are implemented as software that is executed on the computing device and that have subscribed to the command.

### BACKGROUND

The variety of techniques with which a user may interact with a computing device is ever increasing. For example, a user traditionally interacted with a computing device using a keyboard. Techniques were then developed to support a graphical user interface with which a user may interact using a cursor control device (e.g., a mouse) as well as a keyboard.

Subsequent techniques were then developed to interact with the computing device using gestures, which could be detected using touchscreen functionality, a track pad, and so on. However, conventional techniques that were utilized to initiate commands could be resource intensive, especially for later developed techniques such as gestures. Consequently, the range of techniques that could be implemented conventionally could be limited by the resource demands of the techniques, such as to recognize different gestures.

### SUMMARY

Input command techniques are described. In one or more implementations, a computing device processes one or more inputs that are received from one or more input sources to determine a command that corresponds to the one or more inputs. The command is exposed to one or more controls that are implemented as software that is executed on the computing device and that have subscribed to the command.

In one or more implementations, a system includes an adaptation module implemented at least partially in hardware of a computing device to convert one or more inputs received from one or more input sources into one or more corresponding commands. The system also includes a notification module implemented at least partially in hardware of the computing device to notify one or more controls of the computing device of the one or more commands. The system may further include a normalization module implemented at least partially in hardware of the computing device as a device driver to normalize data from the one or more input sources into a lower-bandwidth representation of the data, the lower-bandwidth representation configured for processing by the adaptation module. The system may also include a translation module implemented at least partially in hardware of the computing device to translate data from the one or more input sources from source-specific information into a format that is understandable by the normalization module.

In one or more implementations, a first input is processed by a computing device that is received from a first input source to determine a command that corresponds to the first input. Responsive to the processing of the first input, the command is exposed to one or more controls that are implemented as software that is executed on the computing device. A second input is processed by a computing device that is received from a second input source to determine that the command corresponds to the second input, the second input source of a type that is different than the first input source. Responsive to the processing of the second input, the command is exposed to the one or more controls.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ input command techniques described herein.

FIG. 2 illustrates a system in an example implementation showing a framework that may be employed to implement the input command techniques described herein.

FIG. 3 is a flow diagram depicting a procedure in an example implementation in which a normalization module of an input command module of FIG. 1 is configured to process an input.

FIG. 4 is a flow diagram depicting a procedure in an example implementation in which an adaptation module of the input command module is configured to process an input from the normalization module of FIG. 3.

FIG. 5 is a flow diagram depicting a procedure in an example implementation in which an input command adapter (ICA) of the adaptation module of the input command module of FIG. 4 is configured to determine whether a state is valid for a command.

FIG. 6 is a flow diagram depicting a procedure in an example implementation of a notification module of the input command module as configured to notify command consumers of a command.

FIG. 7 is a flow diagram depicting a procedure in an example implementation in which input processing is performed.

FIG. 8 is a flow diagram depicting a procedure in an example implementation in which input adapters are cycled for a particular command.

FIG. 9 is a flow diagram depicting a procedure in an example implementation in which commands are exposed to controls.

FIG. 10 is a flow diagram depicting a procedure in an example implementation in which inputs from different types of input sources are exposed as commands to one or more controls.

FIG. 11 illustrates an example system that includes the computing device as described with reference to FIG. 1.

FIG. 12 illustrates various components of an example device that can be implemented as any type of computing device as described with reference to FIGS. 1, 2, and 11 to implement embodiments of the techniques described herein.

### DETAILED DESCRIPTION

Overview

Conventional input command techniques mandated that a developer consider each input source at a control level. Therefore, the developer was forced to address each input source to be supported by software written by the developer. Although this was generally sufficient for conventional input sources such as a keyboard and cursor control device, these techniques do not scale and result in duplicated code when addressing input sources such as touch functionality and cameras that may be used to support gestures.

Input to command adaptation techniques are described. In one or more implementations, a system is described that may be implemented to divide input processing into discrete phases. Further, the system may leverage command subscription such that portions of software may determine whether execution of the portion is warranted and respond accordingly. For example, execution of gesture recognition code for a two-handed clapping gesture may be avoided if there are no consumers for the command. In this way, developers can configure command consumers to subscribe to desired commands, and the input system executes corresponding parts of the system as warranted. Therefore, code that does not have an “interested party” at the end of an input pipeline is not executed, thereby conserving resources of the computing device, further discussion of which may be found in relation to the following sections.

In the following discussion, an example environment is first described that is operable to employ the techniques described herein. Example procedures are then described, which may be employed in the example environment as well as in other environments. Accordingly, the example environment is not limited to performing the example procedures. Likewise, the example procedures are not limited to implementation in the example environment.

Example Environment

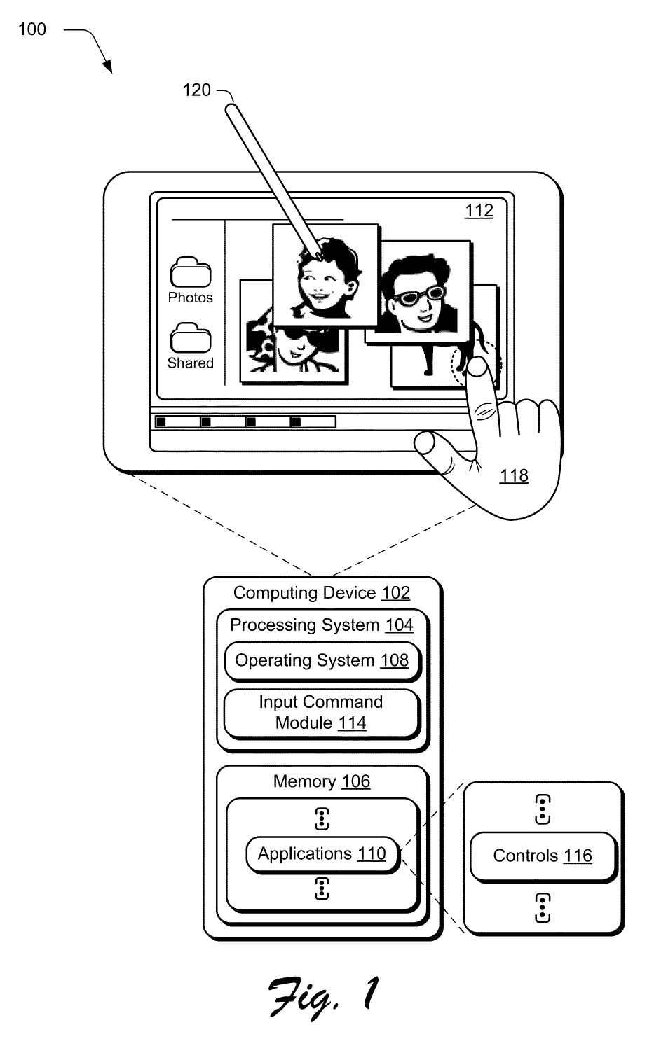

FIG. 1 is an illustration of an environment 100 in an example implementation that is operable to employ input command techniques described herein. The illustrated environment 100 includes a computing device 102 having a processing system 104 and a computer-readable storage medium that is illustrated as a memory 106 although other confirmations are also contemplated as further described below.

The computing device 102 may be configured in a variety of ways. For example, a computing device may be configured as a computer that is capable of communicating over a network, such as a desktop computer, a mobile station, an entertainment appliance, a set-top box communicatively coupled to a display device, a wireless phone, a game console, and so forth. Thus, the computing device 102 may range from full resource devices with substantial memory and processor resources (e.g., personal computers, game consoles) to a low-resource device with limited memory and/or processing resources (e.g., traditional set-top boxes, hand-held game consoles). Additionally, although a single computing device 102 is shown, the computing device 102 may be representative of a plurality of different devices, such as multiple servers utilized by a business to perform operations such as by a web service, a remote control and set-top box combination, an image capture device and a game console configured to capture gestures, and so on.

The computing device 102 is further illustrated as including an operating system 108. The operating system 108 is configured to abstract underlying functionality of the computing device 102 to applications 110 that are executable on the computing device 102. For example, the operating system 108 may abstract the processing system 104, memory 106, network, and/or display device 112 functionality of the computing device 102 such that the applications 110 may be written without knowing “how” this underlying functionality is implemented. The application 110, for instance, may provide data to the operating system 108 to be rendered and displayed by the display device 112 without understanding how this rendering will be performed. The operating system 108 may also represent a variety of other functionality, such as to manage a file system and user interface that is navigable by a user of the computing device 102.

The computing device 102 is also illustrated as including an input command module 114. The input command module 114 is representative of functionality of the computing device 102 to process inputs prior to handling by one or more controls 116. Although illustrated separately as a stand-alone module, the input command module 114 may be implemented in a variety of ways, such as part of the operating system 108, as part of one or more applications 110, and so on.

The input command module 114 may be configured to provide an output as an indication of a command to one or more controls 116. Therefore, instead of forcing the controls 116 to process inputs such as “click” or “key down,” the control 116 may be configured to respond to commands configured as a semantic entity such as “print,” “zoom,” and so forth. Thus, complication of coding by developers of the applications 110 and other software (e.g., even the operating system 108 itself) may be lessened and even avoided across disparate input sources.

For example, the computing device 102 may be configured to initiate a zoom operation in a variety of ways. This may include detecting movement of fingers of a user's hand 118 for a zoom gesture, a tap of a stylus 120, a keyboard combination, a spoken command in voice recognition, use of a cursor control device (e.g., a combination of a press of a control key and movement of a scroll wheel), motions captured by a depth-sensing camera, and so on. Using the techniques described herein, however, the input command module 114 may recognize these different inputs and notify a consumer of that command when warranted, in this case consumers of the command relating to use of a zoom command.

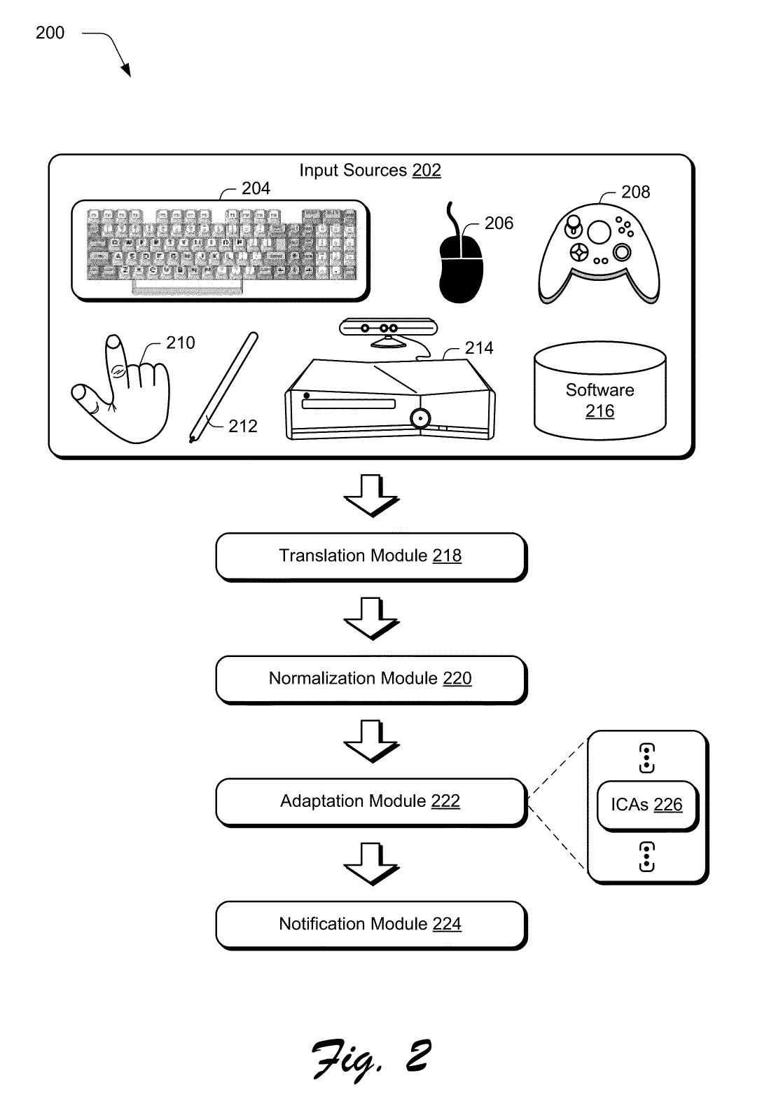

Additionally, these techniques may be used to support whether the computing device 102 is to be configured to “look for” different inputs at any one time. For example, the input command module 114 may be configured to include a variety of different modules, each corresponding to a different type of command. Command consumers may then subscribe to the different modules to be made aware when initiation of a corresponding command has occurred. Therefore, if a particular module does not have a subscriber, execution of the module may be avoided, thereby conserving resources of the computing device. Further discussion of this and other examples may be found in relation to FIG. 2.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

For example, the computing device 102 may also include an entity (e.g., software) that causes hardware of the computing device 102 to perform operations, e.g., processors, functional blocks, and so on. For example, the computing device 102 may include a computer-readable medium that may be configured to maintain instructions that cause the computing device, and more particularly hardware of the computing device 102 to perform operations. Thus, the instructions function to configure the hardware to perform the operations and in this way result in transformation of the hardware to perform functions. The instructions may be provided by the computer-readable medium to the computing device 102 through a variety of different configurations.

One such configuration of a computer-readable medium is signal bearing medium and thus is configured to transmit the instructions (e.g., as a carrier wave) to the hardware of the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

FIG. 2 depicts a system 200 in an example implementation showing a framework that may be employed to implement the input command techniques described herein. Software may be configured to detect and respond to various input sources, which historically involved a keyboard 204 and cursor control device 206 (e.g., mouse). As previously described, software may also be configured for a variety of other input sources that were subsequently developed, examples of which are illustrated as a game controller 208, recognition of a touch input 210, a stylus 212, use of a camera 214 to support a natural user interface to detect gestures without involving physical contact, other software 216, a microphone for speech input, and so on.

Using conventional techniques, developers were forced to consider each of the input sources 202 at a control level. Consequently, the developer was often forced to address each new input source individually. For example, to allow a button to be “pressed”, the developer may add code to respond to a mouse click, a key entry (e.g. Enter), a tap on a touch surface, and so on. This may lead to code duplication across controls, and may make it increasingly difficult to homogenize input patterns. Additionally, the amount of code involved in addressing each input source may expand to address new input sources, such as to respond to the introduction of camera and touch recognized gestures, voice commands, and other input sources.

Conventional solutions allowed commands to be bound to inputs at the user interface (UI) level, which was an abstraction on delivery of the raw input to the UI. However, this still involved processing of the inputs at the UI, which left input processing in the hands of the control developer. This could be desirable in some instances, such as in the case of keyboard input to a text box, but more oftentimes was not. One limitation of this conventional technique is that developers were still forced to reference individual input methods on each implementation or base implementation of a control. Consequently, this may lead to a proliferation of input-handling code and a corresponding increase in complexity and a decrease in code quality.

In addition to the increases in complexity described above, conventional techniques did not account for the higher computation costs associated with the increase in input sources, e.g., to recognize gestures. For example, inputs were traditionally considered an “instant” event in that there was a single instance in time in which a button was pressed (e.g., on a keyboard), or could involve multiple single instances (e.g., a scenario in which a mouse button was depressed at a first point in time and the mouse button was released at a second point in time), and so forth.

Non-instantaneous events may also be received at the computing device. However, conventional techniques generally treated non-instantaneous events as instantaneous events. For example, individual “mouse moved” events may be received and processed individually as a mouse is continuously moved. In another example, a gesture such as “drag-and-drop” may also be processed as a series of events to initiate a corresponding operation. Consequently, in a gesture-based system, recognition code processes these inputs using “snapshots of state.” A gesture event is then generated when a definition of a gesture has been met. Accordingly, this processing can take a significant amount of resources of the computing device 102, e.g., consume a significant amount of resources of the processing system 104 and memory 106.

Further, conventional techniques do not permit automatic conditional processing of a complex input. Although complex input processing may be turned “on” or “off” by a developer coding a user interface, the user interface developer was still forced to be aware of and control the input system when using conventional techniques.

Input command techniques are described herein. In one or more implementations, these techniques may follow a phased approach to input processing, thereby allowing complex inputs to be normalized and simplified prior to handling by UI controls. Rather than responding to clicks, keys, or gestures, for instance, the controls may be configured to respond to commands. For example, a command may be defined as a semantic entity such as “print,” “zoom,” “exit program,” and so forth. This is in contrast to inputs, examples of which include “click,” “key down,” “hand is initiating a waving gesture,” and so forth.

Therefore, when a new control is desired, the developer may register to which commands the control subscribes, rather than which inputs. Inputs may be bound dynamically to commands through an adaptation layer as further described below. In one or more implementations of this technique, an input is processed through four discrete layers, which are represented in FIG. 2 using respective modules as a translation module 218, normalization module 220, adaptation module 222, and notification module 224 and discussed in the following sections, respectively.

Translation Module 218

The translation module 218 is illustrated as being configured to receive inputs from a variety of different input sources 202 as previously described. The input sources may be configured as hardware (e.g. a cursor control device 206 or camera 214) or software 216 (e.g. test automation or network commands). The translation module 218 is representative of functionality (e.g., a layer) to translate an input from source-specific information into a format understandable by the software framework of an application 110.

Examples of translation include conversion of network packets into data structures, CMOS camera data into a bitmap image, keyboard scan codes into virtual key codes (VKs), and so forth. Thus, the translation module 218 may be configured to translate each input source into application-readable formats. Example implementations of a translation module 218 include device drivers.

Normalization Module 220

The normalization module 220 is illustrated in the example system 200 as receiving an output of the translation module 218. The normalization module 220 is representative of functionality to generate a representation of the data output by the translation module 218, which may be a lower-bandwidth representation.

Under conventional techniques, raw data was adapted directly by end-consumers/controls that generate a user interface. Consequently, this may result in duplicative processing of the data and a corresponding increase in code complexity in the consuming control. This is because for conventional inputs (e.g., for a key down event) there is relatively little processing to be performed in this phase. However, as input techniques have progressed (e.g., to recognize finger gestures from a multitude of data points) the resources consumed by the computing device 102 to perform this processing have also increased.

However, in the techniques described herein the normalization module 220 may be utilized to normalize inputs, which may include recognition of gestures described in the data received from the translation module 218. This recognition and other input state may then be made available for inspection by the adaptation module 222. This phase may be computationally expensive and/or complex depending on the input data, e.g., a gesture versus a key down event. However, by including this functionality as part of the normalization module 220 duplication of this complexity and processing may be reduced and even avoided.

Adaptation Module 222

The adaptation module 222 is representative of functionality to convert the output of the normalization module 222 into a representation of one or more commands. In one or more implementations, the input-specific data is converted to command-specific data by code designed to address each specific input type and command type. This conversion may be lightweight (in regard to resource consumption of the computing device 102) and may leverage computations completed during normalization by the normalization module 220.

The output of the adaptation module 22 may be configured to provide an output that is semantically relevant to the command. For example, a zoom command may include a “zoom by ‘x’ percent” floating point number value.

The adaption module 222 is illustrated as including one or more input command adapters 226 (ICAs). The ICAs 226 are representative of functionality of the computing device 102 to convert inputs for a particular command. To convert a game controller's analog trigger input to a zoom command, for instance, an ICA 226 may take a percentage of travel on a trigger (as calculated during normalization) and multiply it by zoom sensitivity configuration setting of an application 110. In another instance, to convert a two-handed hand clapping gesture to a zoom command, an ICA 226 may use a difference in distances between a current and starting hand positions and calculate the progress along the gesture. It should be readily apparent that there are as many possibilities for adaptation as there are combinations of inputs for a particular command command. Thus, the adaptation module 222 may be utilized to solve each combination once, rather than at multiple times at a control level.

The adaptation module 222 may also be configured to make a determination as to whether initiation of a command is warranted. In the example of a trigger-to-zoom ICA, for instance, a zoom command may be configured to be initiated responsive to a zoom value that exceeds a defined threshold. In another instance of a two-handed clapping gesture to zoom, the zoom command may be initiated responsive to successful recognition of the gesture.

Notification 224

The notification module 224 is representative of functionality to output a notification of a command to software that is configured to consume the command. Accordingly, this software may also be referred to as a “command consumer” in the following discussion.

The notification module 224, for instance, may be configured to support subscription based techniques in which command consumers are configured to subscribe to commands of interest. In this way, subscribers to ICAs 226 may be notified of invocation of one or more commands and react accordingly, such as to perform one or more operations specified by the command consumer as corresponding to that command. The notification may be accomplished in a variety of ways, such as message passing, events, setting a state that is polled at periodic intervals, and so on.

Thus, the system 200 described above may be used to divide input processing into discrete phases. Further, the system 200 may leverage command subscription such that portions of software may determine whether execution of the portion is warranted. For example, execution of gesture recognition code for a two-handed clapping gesture may be avoided if there are no command consumers that are currently subscribed to an ICA 226 for associated commands. This determination may be made by querying for ICA subscribers to the gesture. If an ICA 226 is subscribed to the gesture, then the gesture code is executed. Thus, resources of the computing device 102 may be conserved.

In one or more implementations, ICAs 226 are automatically subscribed to their input sources 202 when a corresponding command for the ICA receives a subscription for the first time. In this manner, developers can configure command consumers to subscribe to desired commands, and the input system “wires up” the normalization, adaptation, and notification modules 220, 222, 224 in response as warranted. Therefore, code that does not have an “interested party” at the end of the input pipeline is not executed, thereby conserving resources of the computing device 102, further discussion of which may be found in relation to the following procedures.

Example Procedures

The following discussion describes input command techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the system 200 of FIG. 2.

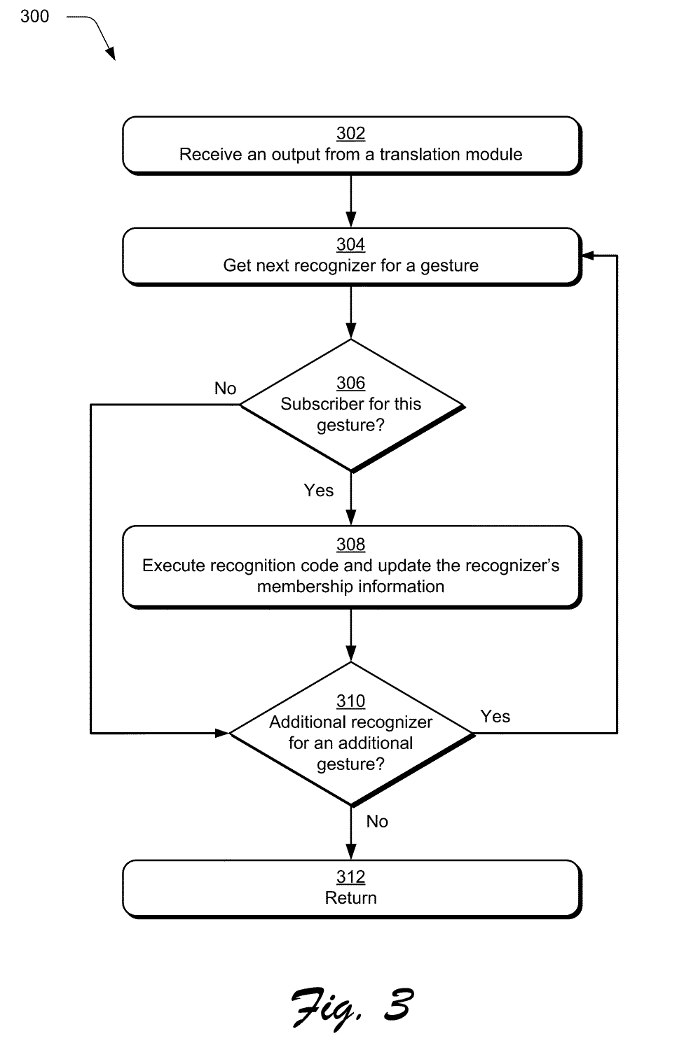

FIG. 3 depicts a procedure 300 in an example implementation in which a normalization module 220 of the input command module 114 is configured to process an input as pertaining to particular commands. A normalization module 220 receives an output from the translation module 218 (block 302). As previously described, the translation module 218 may be configured to translate an input from source-specific information into a format understandable by the software framework of an application 110, such as through implementation as a device driver.

In the following example, a recognizer for a gesture is obtained (block 304). The recognizer, for instance, may be configured as a module that pertains to a particular gesture or other command of the computing device 102. The normalization module 220 may then determine if there is a subscriber for this gesture (decision block 306) or other command.

If so (“yes” from decision block 306), recognition code of the recognizer is executed and the recognizer's membership information is updated (block 308). Thus, the recognizer in this instance is executed responsive to a determination that an output of the recognizer is desired, i.e., there is a command consumer that is interested in the corresponding command. In this way, resources of the computing device 102 may be conserved.

After execution of the recognition code and update (block 308) or if there is no subscriber for this command (“no” from decision block 306), a determination is then made as to whether an additional recognizer is available for an additional gesture (block 310) or other command. If so (“yes” from decision block 310), the next recognizer for the gesture is obtained (block 304) and if not, the procedure 300 returns (block 312).

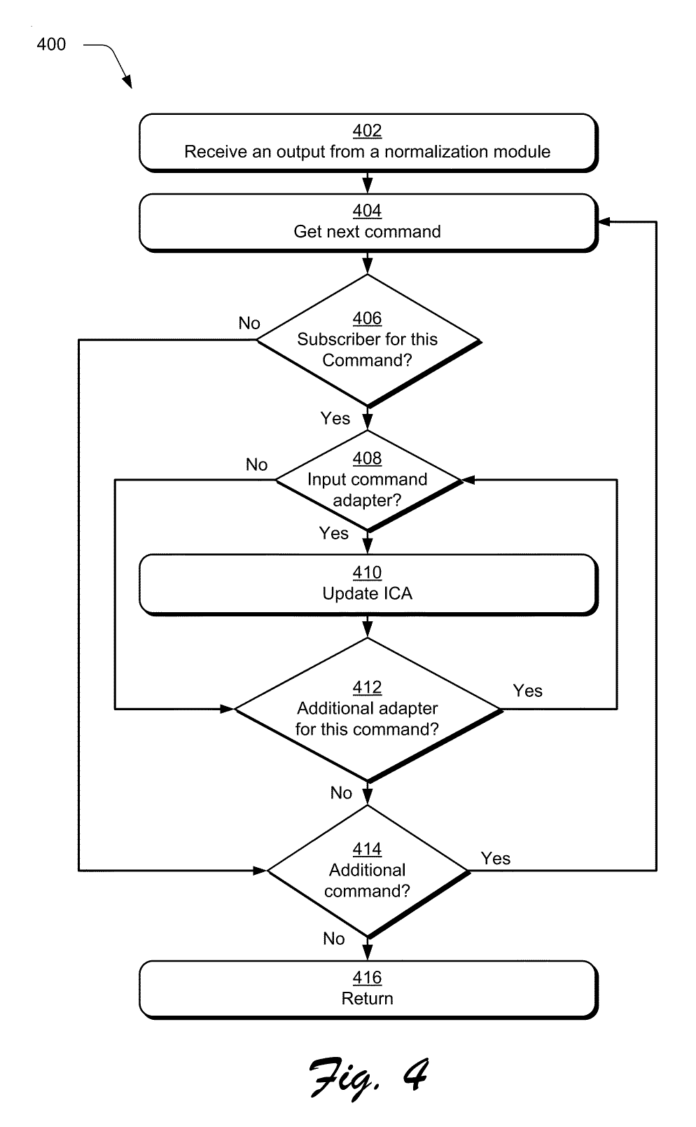

FIG. 4 depicts a procedure 400 in an example implementation in which an adaptation module 222 of the input command module 114 is configured to process an input from the normalization module 220 of FIG. 3. An output is received from a normalization module (block 402) as described in relation to FIG. 3. In response, the adaptation module 222 may obtain information relating to a command described by the output (block 404).

This information may then be used to determine whether there is a subscriber for this command (decision block 406). If so (“yes” from decision block 406), a determination is made as to whether an input command adapter is available for this command (decision block 408). An input command adapter, as previously described, may be configured as a module to convert a command to one or more controls, such as a two-handed clapping gesture captured using a camera to a zoom. If an input command adapter is available (“yes” from decision block 408), the input command adapter is updated. This may include providing the information to the adapter to determine whether a definition of the control has been complied with, e.g., a threshold amount of zoom and so on.

After the ICA is updated (block 410) or the input command adapter is not available (“no” from decision block 408), a determination is made as to whether an additional command is available (decision block 414) from the information obtained from the normalization module 220. If so (“yes” from decision block 414) the next command is obtained (block 404). If not (“no” from decision block 414), the procedure 400 returns (block 416).

Thus, in this example the adaptation module is configured to provide an output received from the normalization module to one or more ICAs that have subscribed to the output, i.e., have subscribed to one or more commands in that output. The ICAs may then process this information, further description of which may be found in relation to the following figure.

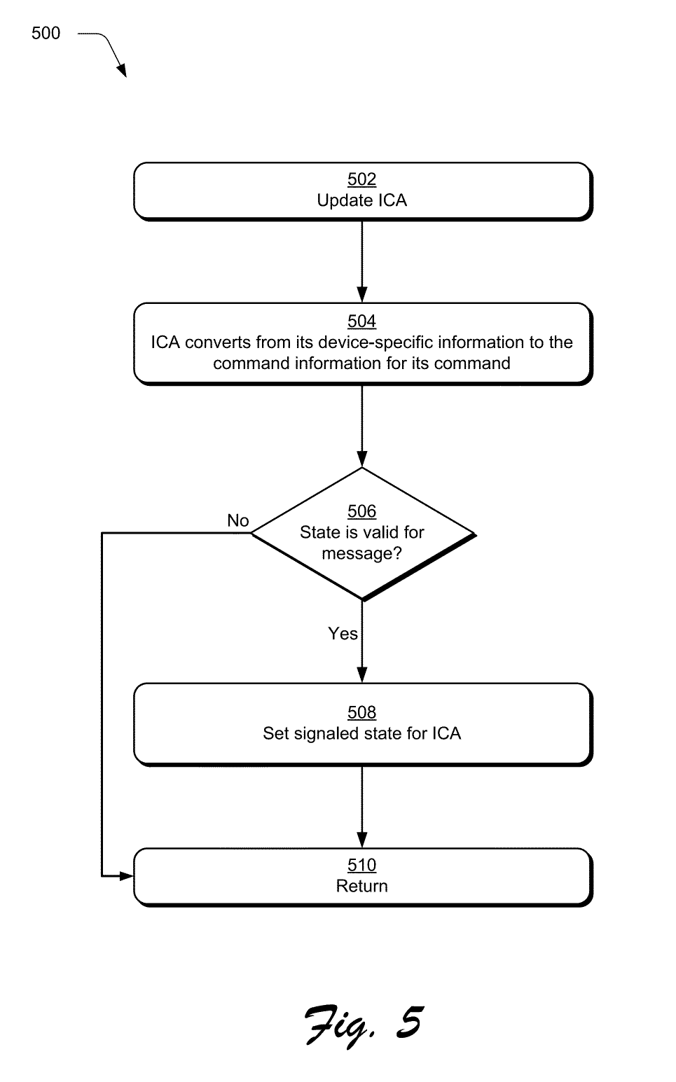

FIG. 5 depicts a procedure 500 in an example implementation in which an ICA of the adaptation module 222 of the input command module 114 is configured to determine whether a state is valid for a command. An ICA is updated (block 502) by the adaptation module 220 using data obtained from the normalization module 220. In this example, the adaptation module 222 is configured to choose which of a plurality of ICAs 226 correspond to the command received from the normalization module 220.

The ICA converts the device-specific information into command information for its command (block 504). The ICA, for instance, may receive data that describe an amount of movement and corresponding key presses and convert this information into a form that follows semantics for that control. A determination is then made as to whether the state is valid for the message (decision block 506). This may include whether the semantic representation is sufficient to indicate initiation of the control, is compatible with the control, and so on.

If the state is valid for the message (“yes” from decision block 506), the signaled state is set for the ICA (block 508) and thus the ICA 226 may indicate that the command is available to be consumed by the control. If the state is not valid for the message (“no” from decision block 506) or after the signaled state is set for the ICA (block 508), the procedure may return (block 510).

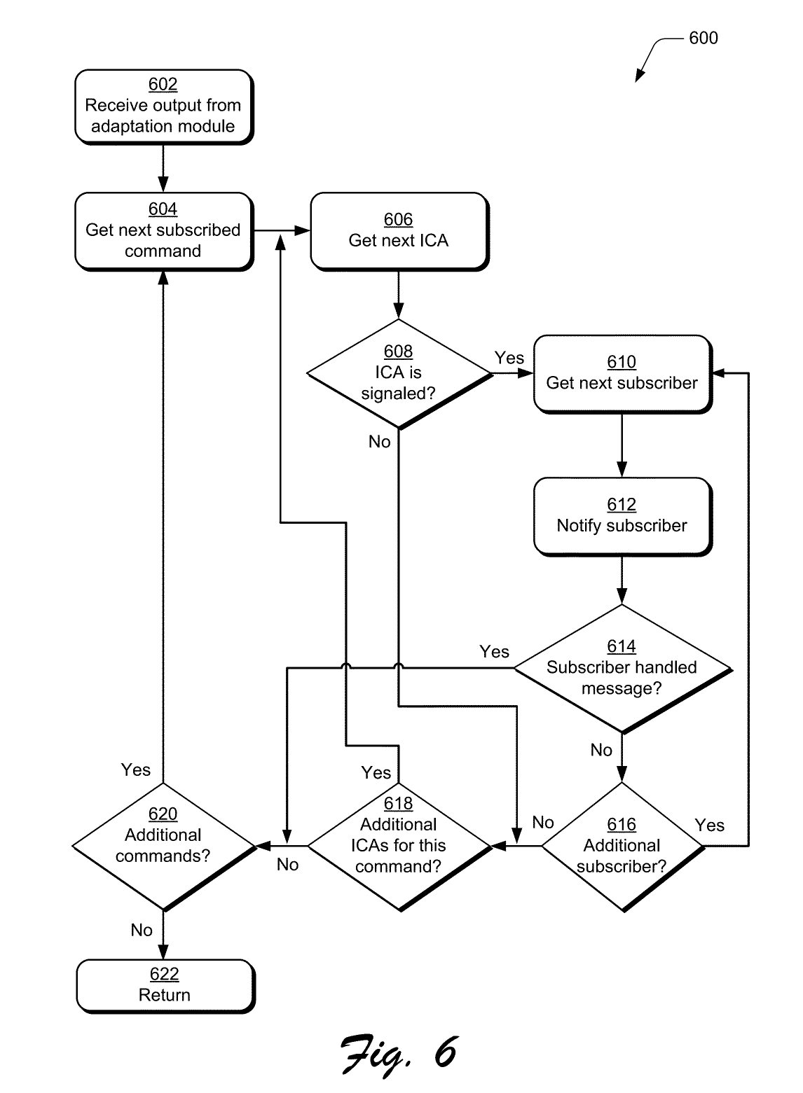

FIG. 6 depicts a procedure 600 in an example implementation in a notification module 224 of the input command module 114 is configured to notify command consumers of a command. The notification module 224 receives an output from the adaptation module 222 (block 602) as described in relation to FIG. 5. In response, the notification module obtains a command that has one or more subscribers (block 604) and obtains an ICA for that command (block 606).

A determination is made as to whether the ICA is signaled (decision block 608), e.g., the ICA 226 is in a signaled state. If so (“yes” from decision block 610), information for a subscriber for the ICA 226 is obtained (block 610) and the subscriber is notified (block 612). A determination is then made as to whether the subscriber handled the message (decision block 614) and if so (“yes” from decision block 616), information for a next subscriber is obtained (block 610). Thus, this portion of the procedure 600 may be repeated for each subscriber to the ICA.

Once there are no additional subscribers to the ICA (“no” from decision block 616) or the ICA is not signaled (“no” from decision block 608), a determination is made as to whether additional ICAs are available for this command (decision block 618). If so (“yes” from decision block 618), the next ICA is obtained (block 606). If not (“no” from decision block 618), a determination is then made as to whether additional commands are available (decision block 620). If so (“yes” from decision block 620), the next subscribed command is obtained by the normalization module (block 604). If not (“no” from decision block 620), the procedure 600 returns.

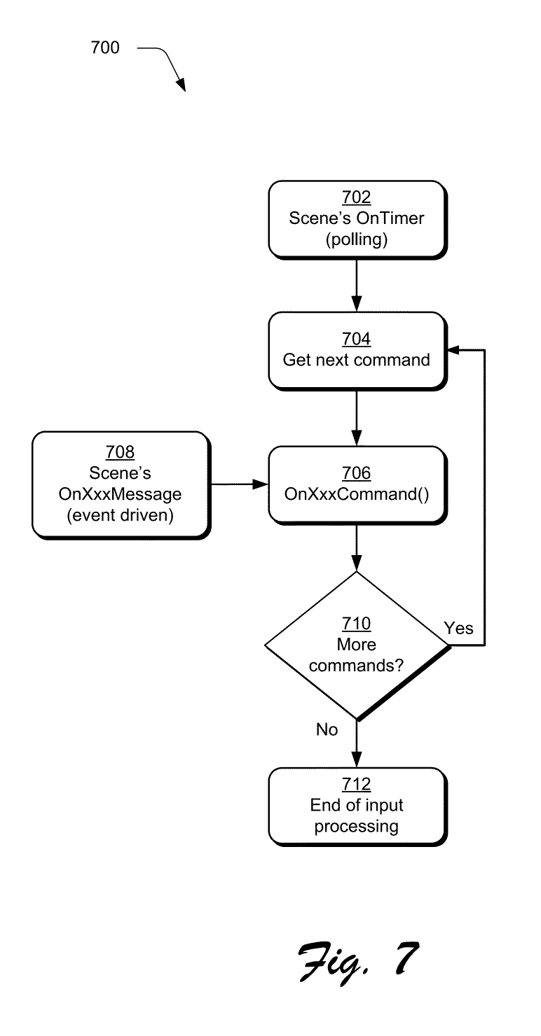

FIG. 7 depicts a procedure 700 in an example implementation in which input processing is performed. A polling interval is reached for a scene's time (block 702). In response, a command is obtained (block 704). This may include obtaining a command, which is illustrated as an “OnXxxCommand( )” (block 706) from a scene's OnXxxMessage (block 708), which may be event driven.

A determination is then made as to whether there are additional commands (decision block 710). If so (“yes” from decision block 710), the next command is obtained (block 704). If not (“no” from decision block 710), input processing is ended (block 712).

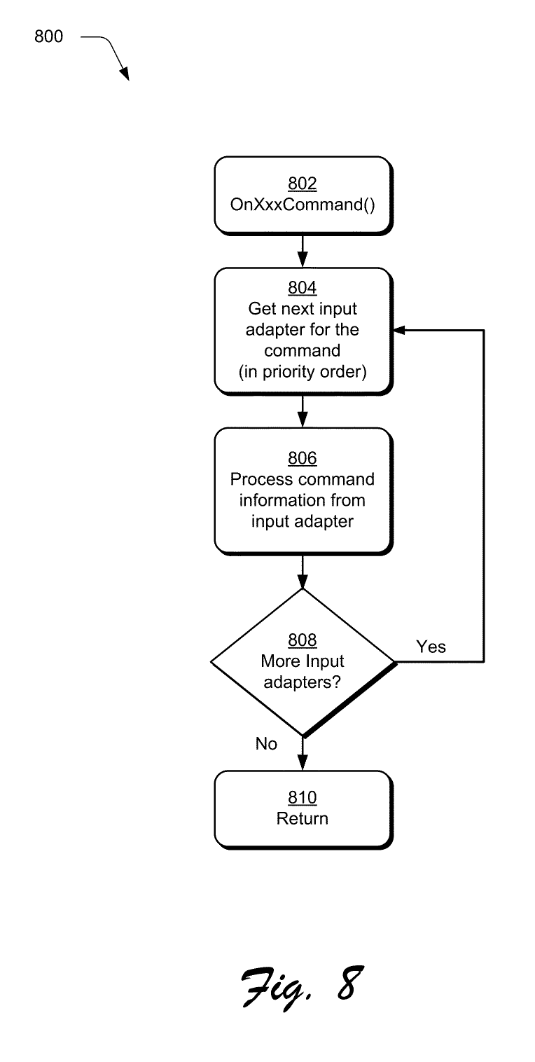

FIG. 8 depicts a procedure 800 in an example implementation in which input adapters are cycled for a particular command. The “OnXxxCommand( )” is obtained (block 802) as described in FIG. 7. A next input adapter for the command is obtained (block 804), which may be performed in a priority order. Command information for the input adapter is processed (block 806). A determination is then made as to whether additional input adapters are available (decision block 808). If so (“yes” from decision block 808), the next input adapter is obtained (block 804). If not (“no” from decision block 808), the procedure 800 returns.

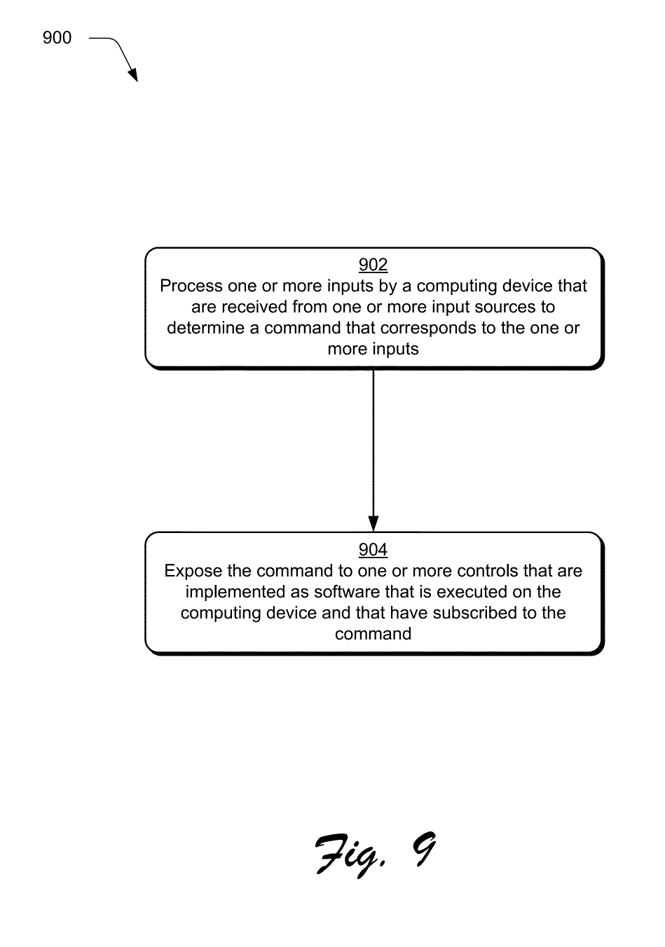

FIG. 9 depicts a procedure 900 in an example implementation in which commands are exposed to controls. A computing device processes one or more inputs that are received from one or more input sources to determine a command that corresponds to the one or more inputs (block 902). The computing device 102, for instance, may employ in input command module 114 to process inputs received from one or more sources. As previously described, the input command module 114 may be configured in a variety of ways, such as a stand-alone module, part of an operating system 108, application 110, and so on.

The command is exposed to one or more controls that are implemented as software that is executed on the computing device and that have subscribed to the command (block 904). The command, for instance, may be exposed as a semantic entity, such as “print,” “exit program,” “zoom,” or so on rather than the inputs that were used to indicate the command. In this way, the processing may be performed by an entity other than the controls themselves, thereby conserving resources of the computing device 102.

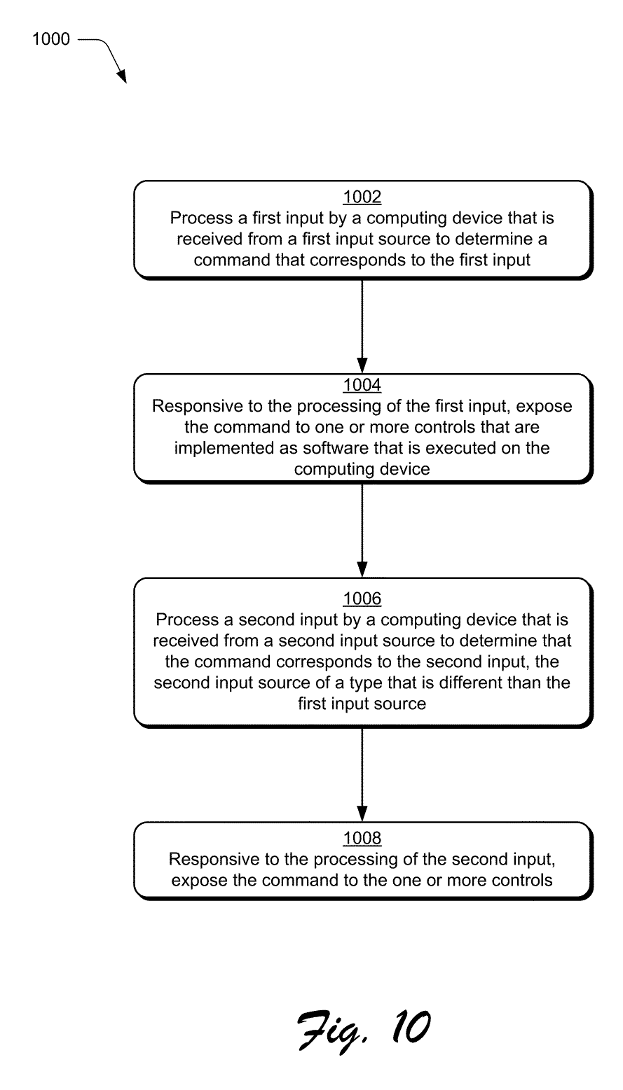

FIG. 10 depicts a procedure 1000 in an example implementation in which inputs from different types of input sources are exposed as commands to one or more controls. A first input is processed by a computing device that is received from a first input source to determine a command that corresponds to the first input (block 1002). Responsive to the processing of the first input, the command is exposed to one or more controls that are implemented as software that is executed on the computing device (block 1004). As before, the first input may be received by an input command module 114.

A second input is processed by a computing device that is received from a second input source to determine that the command corresponds to the second input, the second input source of a type that is different than the first input source (block 1006). Responsive to the processing of the second input, the command is exposed to the one or more controls (block 1008). As described in relation to FIG. 2, a variety of different input sources may be used to input a command, which may include keyboard, cursor control device, voice recognition, as well as gestures detected using touchscreen functionality and/or a camera. Some of these input sources may consume a significant amount of resources to detect the input, such as a gesture. Therefore, by employing the input command module 114 as described herein this detection may be performed “outside” of the code of the control itself, thereby conserving resources of the computing device 102.

Example System and Device

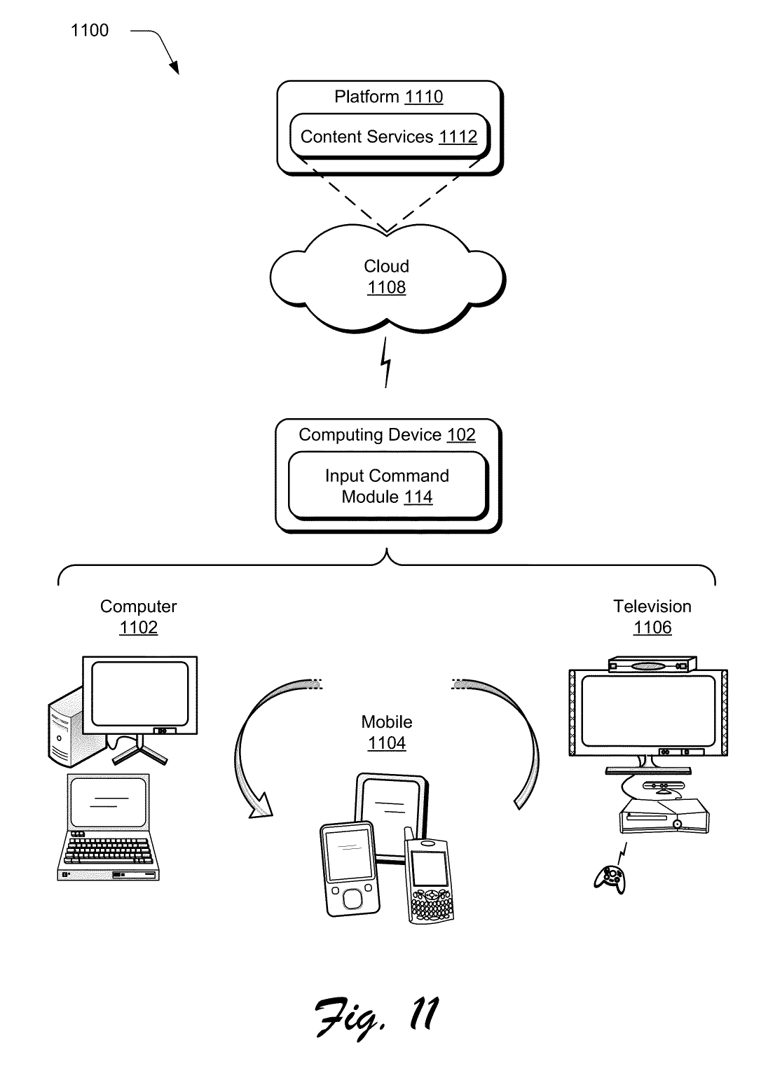

FIG. 11 illustrates an example system 1100 that includes the computing device 102 as described with reference to FIG. 1. The example system 1100 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1100, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 102 may assume a variety of different configurations, such as for computer 1102, mobile 1104, and television 1106 uses. Each of these configurations includes devices that may have generally different constructs and capabilities, and thus the computing device 102 may be configured according to one or more of the different device classes. For instance, the computing device 102 may be implemented as the computer 1102 class of a device that includes a personal computer, desktop computer, a multi-screen computer, laptop computer, netbook, and so on.

The computing device 102 may also be implemented as the mobile 1104 class of device that includes mobile devices, such as a mobile phone, portable music player, portable gaming device, a tablet computer, a multi-screen computer, and so on. The computing device 102 may also be implemented as the television 1106 class of device that includes devices having or connected to generally larger screens in casual viewing environments. These devices include televisions, set-top boxes, gaming consoles, and so on. The techniques described herein may be supported by these various configurations of the computing device 102 and are not limited to the specific examples the techniques described herein. This is illustrated through inclusion of the input command module 114 on the computing device 102. This functionality may also be implemented all or in part through use of a distributed system, such as over a “cloud” 1108 via a platform 1110.

The cloud 1108 includes and/or is representative of a platform 1110 for content services 1112. The platform 1110 abstracts underlying functionality of hardware (e.g., servers) and software resources of the cloud 1108. The content services 1112 may include applications and/or data that can be utilized while computer processing is executed on servers that are remote from the computing device 102. Content services 1112 can be provided as a service over the Internet and/or through a subscriber network, such as a cellular or Wi-Fi network.

The platform 1110 may abstract resources and functions to connect the computing device 102 with other computing devices. The platform 1110 may also serve to abstract scaling of resources to provide a corresponding level of scale to encountered demand for the content services 1112 that are implemented via the platform 1110. Accordingly, in an interconnected device embodiment, implementation of functionality of the functionality described herein may be distributed throughout the system 1100. For example, the functionality may be implemented in part on the computing device 102 as well as via the platform 1110 that abstracts the functionality of the cloud 1108.

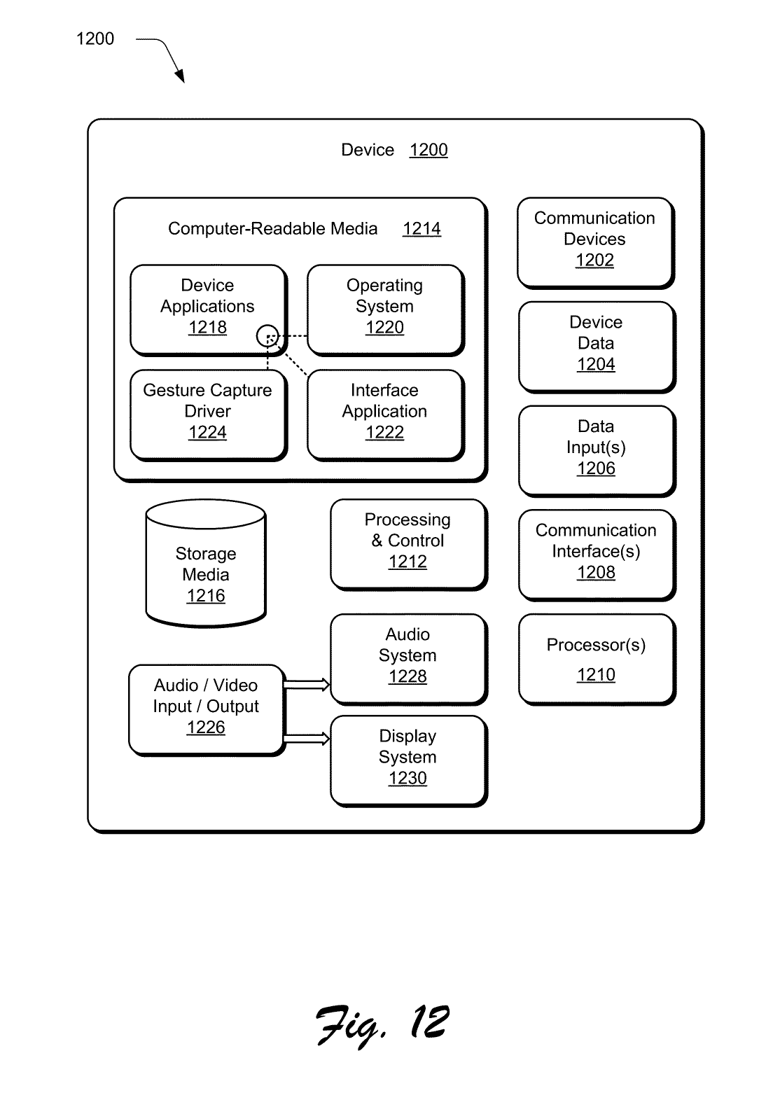

FIG. 12 illustrates various components of an example device 1200 that can be implemented as any type of computing device as described with reference to FIGS. 1, 2, and 11 to implement embodiments of the techniques described herein. Device 1200 includes communication devices 1202 that enable wired and/or wireless communication of device data 1204 (e.g., received data, data that is being received, data scheduled for broadcast, data packets of the data, etc.). The device data 1204 or other device content can include configuration settings of the device, media content stored on the device, and/or information associated with a user of the device. Media content stored on device 1200 can include any type of audio, video, and/or image data. Device 1200 includes one or more data inputs 1206 via which any type of data, media content, and/or inputs can be received, such as user-selectable inputs, messages, music, television media content, recorded video content, and any other type of audio, video, and/or image data received from any content and/or data source.

Device 1200 also includes communication interfaces 1208 that can be implemented as any one or more of a serial and/or parallel interface, a wireless interface, any type of network interface, a modem, and as any other type of communication interface. The communication interfaces 1208 provide a connection and/or communication links between device 1200 and a communication network by which other electronic, computing, and communication devices communicate data with device 1200.

Device 1200 includes one or more processors 1210 (e.g., any of microprocessors, controllers, and the like) which process various computer-executable instructions to control the operation of device 1200 and to implement embodiments of the techniques described herein. Alternatively or in addition, device 1200 can be implemented with any one or combination of hardware, firmware, or fixed logic circuitry that is implemented in connection with processing and control circuits which are generally identified at 1212. Although not shown, device 1200 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1200 also includes computer-readable media 1214, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 1200 can also include a mass storage media device 1216.

Computer-readable media 1214 provides data storage mechanisms to store the device data 1204, as well as various device applications 1218 and any other types of information and/or data related to operational aspects of device 1200. For example, an operating system 1220 can be maintained as a computer application with the computer-readable media 1214 and executed on processors 1210. The device applications 1218 can include a device manager (e.g., a control application, software application, signal processing and control module, code that is native to a particular device, a hardware abstraction layer for a particular device, etc.). The device applications 1218 also include any system components or modules to implement embodiments of the techniques described herein. In this example, the device applications 1218 include an interface application 1222 and an input/output module 1224 that are shown as software modules and/or computer applications. The input/output module 1224 is representative of software that is used to provide an interface with a device configured to capture inputs, such as a touchscreen, track pad, camera, microphone, and so on. Alternatively or in addition, the interface application 1222 and the input/output module 1224 can be implemented as hardware, software, firmware, or any combination thereof. Additionally, the input/output module 1224 may be configured to support multiple input devices, such as separate devices to capture visual and audio inputs, respectively.

Device 1200 also includes an audio and/or video input-output system 1226 that provides audio data to an audio system 1228 and/or provides video data to a display system 1230. The audio system 1228 and/or the display system 1230 can include any devices that process, display, and/or otherwise render audio, video, and image data. Video signals and audio signals can be communicated from device 1200 to an audio device and/or to a display device via an RF (radio frequency) link, S-video link, composite video link, component video link, DVI (digital video interface), analog audio connection, or other similar communication link. In an embodiment, the audio system 1228 and/or the display system 1230 are implemented as external components to device 1200. Alternatively, the audio system 1228 and/or the display system 1230 are implemented as integrated components of example device 1200.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
processing one or more inputs by a computing device that are received from one or more input sources to determine a command that corresponds to the one or more inputs; and
exposing the command to one or more controls that are implemented as software that is executed on the computing device and that have subscribed to the command.

2. A method as described in claim 1, wherein the processing is configured to be performed for a plurality of different types of input sources.

3. A method as described in claim 2, wherein the exposing of the command is performed such that the command is not indicative of the type of input source used to provide the command.

4. A method as described in claim 1, wherein the processing is configured to be performed responsive to a determination that the one or more controls have subscribed to the command.

5. A method as described in claim 1, wherein the processing includes processing an output of a translation module that is configured to translate source-specific information of a corresponding said input source to an application-readable format.

6. A method as described in claim 5, wherein the translation module is implemented as one or more device drivers.

7. A method as described in claim 1, wherein the processing includes normalization of the one or more inputs to produce a lower-bandwidth representation of the one or more inputs.

8. A method as described in claim 1, wherein the processing includes conversion of input-specific data into the command such that the command includes command-specific data that is semantically relevant to the command.

9. A method as described in claim 1, wherein:
the processing includes a determination of whether to invoke the command based on the one or more input sources and a definition of the command; and
the exposing is performed responsive to the determination that the command is to be invoked.

10. A method as described in claim 1, wherein the determination is based on a threshold included in the definition of the command or upon successful recognition of the one or more inputs.

11. A method as described in claim 1, wherein the exposing is performed via message passing, event, or setting a state that is polled by the software that implements the one or more controls on the computing device.

12. A system comprising:
an adaptation module implemented at least partially in hardware of a computing device to convert one or more inputs received from one or more input sources into one or more corresponding commands; and
a notification module implemented at least partially in hardware of the computing device to notify one or more controls of the computing device of the one or more commands.

13. A system as described in claim 12, further comprising a normalization module implemented at least partially in hardware of the computing device as a device driver to normalize data from the one or more input sources into a lower-bandwidth representation of the data, the lower-bandwidth representation configured for processing by the adaptation module.

14. A system as described in claim 12, further comprising a translation module implemented at least partially in hardware of the computing device to translate data from the one or more input sources from source-specific information into a format that is understandable by the adaptation module.

15. A system as described in claim 12, wherein the adaptation module is configured to process inputs from a plurality of different types of input sources into one or more corresponding commands that are not indicative of the type of input sources used to provide the one or more inputs.

16. A method comprising:
processing a first input by a computing device that is received from a first input source to determine a command that corresponds to the first input;
responsive to the processing of the first input, exposing the command to one or more controls that are implemented as software that is executed on the computing device;
processing a second input by a computing device that is received from a second input source to determine that the command corresponds to the second input, the second input source of a type that is different than the first input source; and
responsive to the processing of the second input, exposing the command to the one or more controls.

17. A method as described in claim 16, wherein at least one of the first or second inputs is input via a gesture.

18. A method as described in claim 17, wherein the other of the first or second inputs is not input via a gesture.

19. A method as described in claim 16, wherein the exposing of the first and second commands is performed for the one or more controls responsive to receiving a subscription from the one or more controls to the command.

20. A method as described in claim 16, wherein the exposing of the first and second commands is performed without indicating a respective said type of the first and second input sources, respectively.
